(19) United States
(12) Patent Application Publication
(10) Pub. No.: US 2004/0076826 A1
(43) Pub. Date: Apr. 22, 2004

(54) Microcapsule containing phase change material and article having same

(76) Inventor: Won-Mok Lee, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/611,417

(22) Filed: Nov. 24, 2003

Related U.S. Application Data
(63) Continuation of application No. PCT/KR01/02151, filed on Dec. 12, 2001.

(30) Foreign Application Priority Data
Dec. 29, 2000 (KR) 2000/86203

(51) Int. Cl. B32B 5/16

(52) U.S. Cl. 428/402.24

(57) ABSTRACT

The present invention relates to a microcapsule containing a phase change material and its use, and more particularly, to a microcapsule containing a phase change material wherein phase separation and subcooling thereof cannot be produced and the size of the microcapsule can be reduced to the order of several micrometers, to a method of producing the microcapsule, to an article having enhanced heat-retention capability by comprising the microcapsule, and to a method of producing the article. The microcapsule comprises the phase change material selected from a group consisting of n-octacosane, n-heptacosane, n-hexacosane, n-pentacosane, n-tetracosane, n-tricosane, n-docosane, n-heneicosane, n-eicosane, n-nonadecane, n-octadecane, n-heptadecane, n-hexadecane, n-pentadecane, n-tetradecane, and n-tridecane; and a nucleating agent for preventing subcooling of the phase change material.

### RELATED APPLICATIONS

This application is a continuation under 35 U.S.C. § 365 (c) claiming the benefit of the filing date of PCT Application No. PCT/KR01/02151 designating the United States, filed Dec. 12, 2001. The PCT Application was published in English as WO 02/053370 A1 on Jul. 11, 2002, and claims the benefit of the earlier filing date of Korean Patent Application No. 2000/86203, filed Dec. 29, 2000. The contents of the Korean Patent Application No. 2000/86203 and the international application No. PCT/KR01/02151 including the publication WO 02/053370 A1 are incorporated herein by reference in their entirety.

### FIELD OF THE INVENTION

The present invention relates to a microcapsule containing a phase change material, to a method of producing the microcapsule, to an article having enhanced heat-retention capability by comprising the microcapsule, and to a method of producing the article.

### DISCUSSION OF RELATED TECHNOLOGY

Dependence on energy imports in Korea is at 97.5% as they occupy about 20% of gross domestic imports. Korea is therefore a country with an excessive energy consumption structure. Under the circumstances, since the current price of oil is gradually increasing, there is an urgent need for development of an alternative energy, and to research and develop energy efficiency and energy saving techniques.

In order to improve the energy efficiency, a heat storage method using a phase change material is being actively studied at present. The phase change material is a material capable of absorbing or releasing a lot of heat during phase change thereof from a solid state to a liquid state, from the liquid state to a gaseous state, or vice versa without temperature variation at a specific temperature. Such heat, which the phase change material absorbs or releases while maintaining the same temperature during the phase change thereof, is called latent heat. Heat related to the phase change between the solid state and liquid state is called heat of fusion. Heat related to the phase change between the gaseous state and the liquid or solid state is called heat of vaporization. Water is a material in which the phase change between the solid and liquid states occurs at 0° C. When ice melts at 0° C., the latent heat of fusion of ice is 80 cal/gram. That is, when ice is changed to water, the temperature is maintained at 0° C. until the heat of 80 cal per 1 gram of the ice is absorbed from the surroundings. There exist numerous materials of which phases are changed at different temperatures.

Heretofore, studies to improve energy efficiency using latent heat have been centered on inorganic hydrates or molten salts of Na₂SO₄, CaCl₂, NaHSO₄, etc. as the phase change material. However, there are many difficulties in putting the materials into practice use due to technical limitations such as phase separation, serious subcooling, and bulky volume thereof.

### SUMMARY OF THE INVENTION

The present invention intends to microencapsulate a phase change material so as to achieve improvement of thermal efficiency, temperature control, energy saving, and diversification of its application.

Therefore, an object of the present invention is to provide an ultra-fine microcapsule containing a phase change material selected from a group consisting of specific phase change materials.

Another object of the present invention is to provide an ultra-fine microcapsule containing a phase change material in which subcooling due to an ultra-fine microencapsulation process does not occur.

A further object of the present invention is to provide an article having enhanced heat-retention capability by comprising the ultra-fine microcapsule containing the phase change material.

A still further object of the present invention is to provide a method of producing the ultra-fine microcapsule containing the phase change material, and a method of producing the article comprising the ultra-fine microcapsule produced by the method.

A still further object of the present invention is to provide a method of saving energy through energy efficiency improvement and development of alternative energy by using the article comprising the microcapsule containing the phase change material.

### BRIEF DESCRIPTION OF THE DRAWINGS

FIG. 1 is a graph showing a subcooled state of a phase change material contained in a microcapsule.

FIG. 2 is a graph showing that the subcooled phenomenon does not occur when a nucleating agent is added to the phase change material contained in the microcapsule.

### DETAILED DESCRIPTION OF THE EMBODIMENTS

A phase change material can be selected from a group consisting of n-octacosane, n-heptacosane, n-hexacosane, n-pentacosane, n-tetracosane, n-tricosane, n-docosane, n-heneicosane, n-eicosane, n-nonadecane, n-octadecane, n-heptadecane, n-hexadecane, n-pentadecane, n-tetradecane, and n-tridecane; and a nucleating agent for preventing subcooling of the phase change material.

The specific phase change materials are paraffin hydrocarbons with the number of carbon from 13 to 28. There have been attempts to efficiently use the latent heat accompanied by the phase change of the material by increasing the surface area of the material through microencapsulation thereof.

However, as the conventional microcapsule containing the phase change material and produced according to the previous attempts is reduced in its size to the order of micrometer, there is a problem in that a serious subcooling phenomenon of the phase change material occurs. The subcooling phenomenon means a case where a material is still maintained in a liquid state without crystallization or solidification even though the material is cooled below a melting point thereof, that is, a case where it cannot be expected that the latent heat absorbed or released while maintaining a constant temperature during the solidification or liquefaction is generated. The subcooling phenomenon becomes rapidly heavier in the process of reducing the size of the microcapsule to the order of micrometer, particularly, 100 micrometers or less. It is known that this is because the droplets of molten liquid are reduced in size and the number of crystallization nuclei in each droplet of molten liquid is simultaneously decreased when the molten liquid is phase-changed to the solid state again. If such subcooling phenomenon occurs, an attempt to use the latent heat to be generated during the phase change of the material at a specific temperature ends in failure.

The present invention is to solve the above problems and is characterized in that the microcapsule containing the phase change material further contains a nucleating agent together with the phase change material so that the subcooling of the phase change material can be prevented and thus the phase change material can be easily crystallized at the melting point.

The nucleating agent suitable for preventing the subcooling of the phase change material may comprise one selected from a group consisting of 1-octacosanol, 1-heptacosanol, 1-hexacosanol, 1-pentacosanol, 1-tetracosanol, 1-tricosanol, 1-docosanol, 1-heneicosanol, 1-eicosanol, 1-nonadecanol, 1-octadecanol, 1-heptadecanol, 1-hexadecanol, 1-pentadecanol, 1-tetradecanol, 1-tridecanol, tridecylamine, tetradecylamine, pentadecylamine, hexadecylamine, heptadecylamine, octadecylamine, nonadecylamine, eicocylamine, heneicocylamine, dococylamine, tricocylamine, tetracocylamine, pentacocylamine, hexacocylamine, heptacocylamine and octacocylamine. However, the nucleating agent is not limited thereto but may include various other nucleating agents.

The nucleating material can be added to the phase change material by the amount of about 0.1 to 15% with respect to the weight of the phase change material. However, the amount of the nucleating agent may be varied depending on temperature, and it is preferred that the nucleating agent be used within a range of about 1 to 6%.

The microcapsule according to the present invention can be produced by using a method of coacervation method, an interfacial polymerization method, or an in-situ method, i.e., instantaneously microencapsulating the phase change material within a reactor. The coacervation method is used, for example, to produce a microcapsule with a wall of gelatin and gravure gum. The interfacial polymerization method uses polyurethane as the wall material of the microcapsule. The in-situ method is used when the phase change material is microencapsulated in a wall of urea-formaldehyde resin or melamine-formaldehyde resin. Generally, the in-situ method is desirable in that the microcapsule containing the phase change material can be produced by using the melamine-formaldehyde resin as the wall material, which has superior chemical properties or industrial applicability.

The in-situ method employed in the present invention will be explained in detail.

First, the wall material of the microcapsule is prepared by making a methylol melamine derivative in a process of reacting the melamine and formaldehyde at proper mole fractions under basic conditions. A desired droplet is made by strongly mixing the phase change material as a core material with an emulsifying agent and by stirring and dispersing them. Subsequently, chemical environment for facilitating a polymerization reaction of the prepared wall material at an interface between the wall material and the core material is created. Then, the wall material is cured to be rigid and dense, and thus, the microcapsule capable of enduring a phase change of the core material is obtained.

As for the size of the microcapsule of the present invention produced as such, its diameter is within a range of 0.1 to 1,000 micrometers, preferably 0.1 to 300 micrometers. When the phase change material is produced in the form of the aforementioned microcapsule having the size of the order of micrometers, a surface area thereof on which heat transfer occurs is increased so that the phase change material can be efficiently used.

Proper materials which can be used as the wall material of the microcapsule according to the present invention may include melamine resin, urea resin, gelatin, polyurethane, epoxy, polystyrene, polyvinyl alcohol, and the like. However, they are not limited thereto.

Meanwhile, firstly, the phase change material in the microcapsule according to the present invention is enclosed by the polymer matrix wall material of the microcapsule which is densely polymerized. Secondly, upon production of an article comprising the microcapsule, the microcapsule is impregnated into another resin and thus the phase change material of the microcapsule is enclosed by a second wall of the resin. Accordingly, since the phase change material in the microcapsule is prevented from leaking out, there is an advantage in that repetitive and reversible use can be made.

The below table shows the desirable phase change materials for use in the present invention, the number of carbon atoms thereof, and melting points thereof.

| | Number of | Melting point |
|---|---|---|
| Name of materials | carbon atoms | (° C.) |
| n-octacosane | 28 | 61.4 |
| n-heptacosane | 27 | 59.0 |
| n-hexacosane | 26 | 56.4 |
| n-pentacosane | 25 | 53.7 |
| n-tetracosane | 24 | 50.9 |
| n-tricosane | 23 | 47.6 |
| n-docosane | 22 | 44.4 |
| n-heneicosane | 21 | 40.5 |
| n-eicosane | 20 | 36.8 |
| n-nonadecane | 19 | 32.1 |
| n-octadecane | 18 | 28.2 |
| n-heptadecane | 17 | 22.0 |
| n-hexadecane | 16 | 18.2 |
| n-pentadecane | 15 | 10.0 |
| n-tetradecane | 14 | 5.9 |
| n-tridecane | 13 | −5.5 |

When each of the phase change materials is microencapsulated, it has the latent heat of fusion of about 150 J to 320 J per 1 gram of the phase change material at the shown relevant melting point thereof. Therefore, the latent heat of the respective phase change materials can be utilized for enhancing the energy efficiency in proper cases according to their respective melting points.

For example, one of the phase change materials which has a melting point of 20° C. or higher may be used to be contained in a flooring material. In the case of a flooring material manufactured by impregnating the phase change material into resin, an aggregate, or the like for constructing the flooring material, when the flooring material is cooled down due to stop of heating thereof after it has been heated so that its temperature is raised up to a certain extent, the phase change material contained in the microcapsule is solidified again at a predetermined temperature and releases a lot of latent heat. Thus, even though the heating thereof is stopped, the flooring material is maintained at a constant temperature for a long time. It is energy effective in that surplus heat can be utilized. In particular, it is useful to a residence system employing a hypocaust such as a Korean floor heater.

Among the materials which can be contained in the flooring material, those which have a melting point falling within a range of 20 to 40° C. can be used in a state where they are impregnated into a surface layer of a plastic flooring sheet or the like exposed directly to the exterior. The materials which have a melting point of 40° C. or higher can be used in a state where they are impregnated into a lower portion of a boiler or the like in which piping is installed or into a concrete base layer around the piping, without exposure to the exterior. In addition, the microcapsule containing such phase change material may be used in a state where it is impregnated into a thermal insulation material which has been standardized beforehand and manufactured in a type of gypsum board. Alternatively, the microcapsule containing the phase change material may be impregnated into proper resin for constructing a flooring sheet as a plastic flooring material so as to produce a standardized plastic flooring material which can be applied in such a manner that it is additionally underlying the existing flooring material.

Meanwhile, such a flooring material may include microcapsules containing two or more different phase change materials, respectively, to utilize the latent heat accompanied by respective phase changes at different temperatures.

One of the above phase change materials which has a melting point between 10 to 38° C. can be microencapsulated to be used for winter clothes such as skiwear. Furthermore, they can be employed in various other clothes such as fire wear, a diving suit, special working clothes, golf wear, a military uniform, a hat, and gloves; and various articles such as shoes, a carpet, and a blanket.

In addition to the above articles, various articles having enhanced heat-retention capability can be produced by using the microcapsule containing the phase change material produced according to the present invention. These articles can be easily produced through the known conventional methods by those skilled in the art.

For example, in the case of the flooring material including the microcapsule containing the phase change material according to the present invention, a flooring material comprising one, two or more layers for constituting a surface layer and a base layer can be produced by impregnating the microcapsule containing the phase change material according to the present invention into any one or two or more of the layers of the flooring material. At this time, as described above, the flooring material may be the flooring sheet exposed to the exterior, or the additional gypsum board or underlying plastic flooring material installed below the surface layer. Here, the microcapsule may be mixed with and impregnated into other resin forming the surface layer or other components for constituting the gypsum board.

The microcapsule containing the phase change material according to the present invention may be applied to fabrics including all kinds of fabrics such as woven fabrics, knits, and non-woven fabrics; yarn; and fibers. As also well known to those skilled in the art, a method of applying the microcapsule containing the phase change material to the fabrics may include spinning, resin coating, a method of putting a pad comprised of the microcapsules over the fabric, a method of impregnating the microcapsule into the fabric, a method of applying it in the form of a down bag, and textile printing.

Meanwhile, when the microcapsule containing the phase change material according to the present invention is applied to various articles such as the aforementioned flooring material or fabrics, it is convenient to mix the microcapsule with various kinds of resin according to its use and subsequently to coat or print the articles with the mixture. The resin used for the purpose may include various kinds of UV paints, acryl, polyurethane, silicon, latex, polyethylene, polypropylene, polyvinyl chloride (PVC), epoxy, polystyrene, ethylene/vinyl acetate (EVA) copolymer, rubber, nitrile rubber, polyvinyl alcohol, butyl cellulose acetate, chloroprene rubber, phenol, neoprene, etc. However, the resin employed in the present invention is not limited thereto.

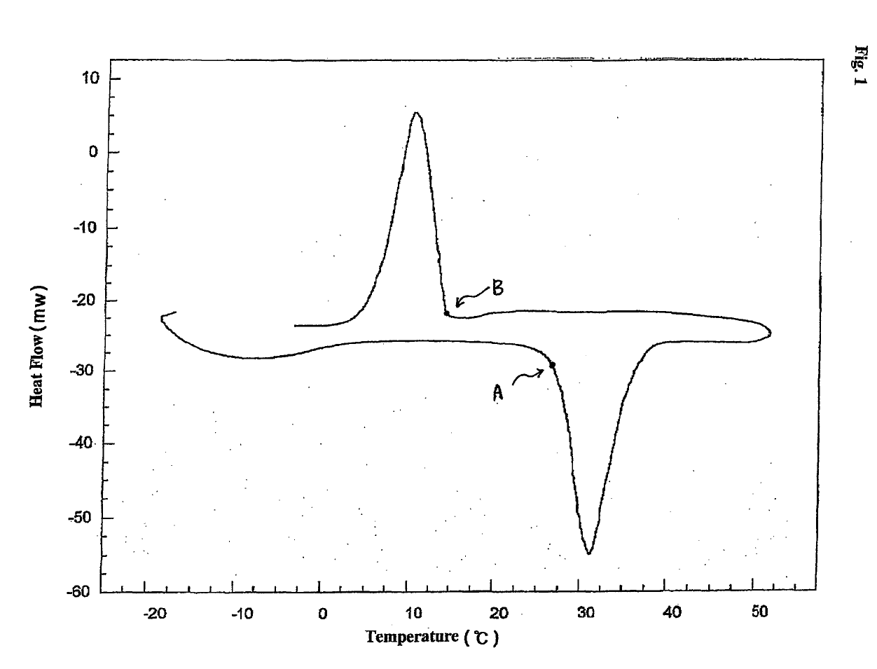

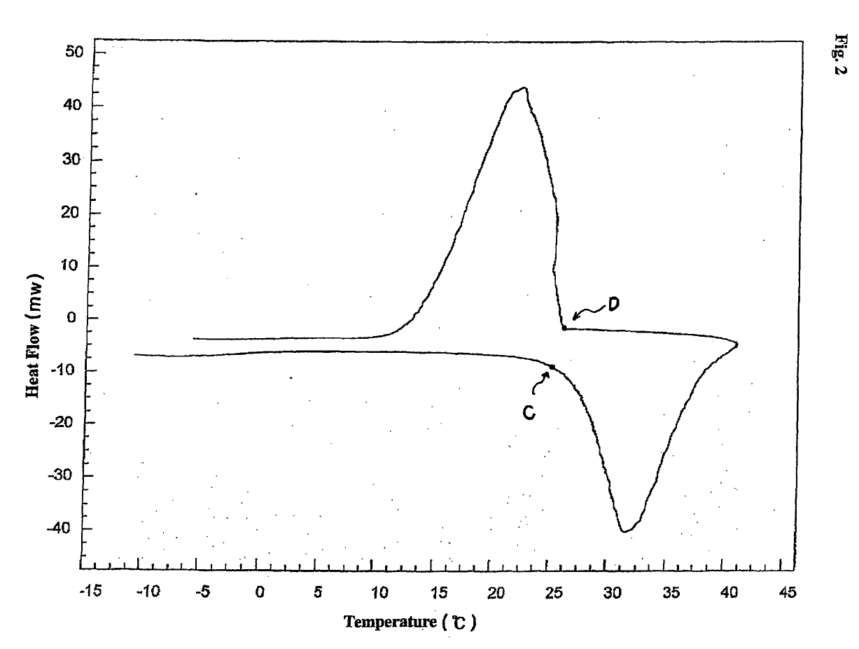

FIGS. 1 and 2 are views showing a subcooled state of a phase change material contained in a microcapsule and alleviation of the subcooled state when a nucleating agent is added in an amount of about 3% to the phase change material according to the present invention, respectively. For the experiment, octadecane was used as the phase change material and 1-octadecanol was used as the nucleating agent.

As can be seen from FIG. 1, before the nucleating agent is added to the phase change material, a solid-state phase change material begins to melt at around 27.09° C. as denoted by point A. However, a temperature at which the phase change material is crystallized again through subsequent cooling after it has melted is not around 27.09° C. which is the melting point mentioned above. As denoted by point B in the FIGURE, the phase change material contained in the microcapsule is not crystallized until it is further cooled down to about 14.71° C. That is, the state between the melting point and the actual crystallization temperature is the subcooled state. In such a case, unless the temperature is lowered to 14.71° C. or lower, the desired crystallization of the material does not occur. Therefore, although heat storage can occur at 27.09° C., release of the stored heat, i.e. latent heat, begins to occur not at 27° C. but around 14° C. Accordingly, due to the subcooling phenomenon, it is impossible to achieve the improvement of the energy efficiency so that the temperature is maintained at around 27° C. of the melting point during a certain period of time.

Referring to FIG. 2, when 1-octadecanol as the nucleating agent is included in the microcapsule together with the phase change material, it can be understood that the melting point (point C) of the phase change material is slightly lower than the solidifying temperature (point D).

In such a way, it should be noted that the method of producing the microcapsule containing the phase change material according to the present invention can solve the subcooling phenomenon which has been a problem upon production of the ultra-fine microcapsule using the phase change material until now.

The aforementioned preferred embodiment of the present invention has been described only for the illustrative purposes and does not limit the present invention. It should be understood that a person having an ordinary skill in the art to which the present invention pertains could make various modifications and changes to the invention without departing from the spirit and scope of the invention defined by the appended claims. The modifications and changes fall within the scope of the present invention.

According to the constitution of the present invention as described above, the phase change material and the nucleating agent are contained in the ultra-fine microcapsule having its size of the order of several micrometers. Thus, it is possible to enhance the heat-retention capability of various articles using the microcapsule. Consequently, in an era of energy shortage, it can be used as alternative energy of which efficiency is remarkably increased.

1. A micorcapsule comprising a shell and a core enclosed in the shell, wherein the core comprises a phase-change material and a nucleating agent for the phase-change material, and wherein the diameter of the core is from about 0.1 μm to about 1,000 μm.

2. The microcapsule of claim 1, wherein the diameter is from about 0.1 μm to about 300 μm.

3. The microcapsule of claim 1, wherein the diameter is from about 0.1 μm to about 100 m.

4. The microcapsule of claim 1, wherein the phase-change material is selected from the group consisting of n-octacosane, n-heptacosane, n-hexacosane, n-pentacosane, n-tetracosane, n-tricosane, n-docosane, n-heneicosane, n-eicosane, n-nonadecane, n-octadecane, n-heptadecane, n-hexadecane, n-pentadecane, n-tetradecane, n-tridecane and a mixture of one or more of the foregoing.

5. The microcapsule of claim 1, wherein the phase-change material is selected from the group consisting of 1-octacosanol, 1-heptacosanol, 1-hexacosanol, 1-pentacosanol, 1-tetracosanol, 1-tricosanol, 1-docosanol, 1-heneicosanol, 1-eicosanol, 1-nonadecanol, 1-octadecanol, 1-heptadecanol, 1-hexadecanol, 1-pentadecanol, 1 tetradecanol, and 1-tridecanol, and a mixture of one or more of the foregoing.

6. The microcapsule of claim 1, wherein the phase-change material has a fewer number of carbon atoms than the nucleating agent.

7. The microcapsule of claim 1, wherein the nucleating agent is from about 0.1% to about 15% with respect to the weight of the phase-change material.

8. The microcapsule of claim 1, wherein the core solidifies at a temperature higher than the melting point thereof.

9. The microcapsule of claim 1, wherein the shell comprises a polymeric material.

10. The microcapsule of claim 1, wherein the phase-change material is a paraffin hydrocarbon with from about 13 to about 28 carbon atoms.

11. A composition comprising a plurality of the microcapsules of claim 1 and another material.

12. The composition of claim 10, wherein the microcapsules form a discrete phase in a continuous phase of the other material.

13. The composition of claim 10, wherein the plurality of the microcapsules comprise the same core.

14. The composition of claim 10, wherein the plurality of the microcapsules comprise two or more different compositions of the core.

15. The composition of claim 10, wherein the microcapsules are in an amount from about 50% to about 95% of the total weight of the composition.

16. The composition of claim 10, wherein the microcapsules are in an amount from about 55% to about 90% of the total weight of the composition.

17. The composition of claim 10, wherein the microcapsules are in an amount from about 65% to about 80% of the total weight of the composition.

18. The composition of claim 10, wherein the composition is in a form of a fabric.

19. The composition of claim 10, wherein the composition is used as a flooring material.
